(19) United States
(12) Patent Application Publication
(10) Pub. No.: US 2003/0024146 A1
(43) Pub. Date: Feb. 6, 2003

(54) Decoy stands

(76) Inventors: Jason E. Spady, Lewellen, NE (US); Steven M. Farris, Woodland Hills, CA (US); Scott A. Weichel, Oshkosh, NE (US)

Correspondence Address: SANFORD ASTOR, SUITE 200, 10507 WEST PICO BLVD., LOS ANGELES, CA, 90064, US

(21) Appl. No.: 09/920,582

(22) Filed: Aug. 1, 2001

(51) Int. Cl. A01M 31/06

(52) U.S. Cl. 43/3

(57) ABSTRACT

The instant invention comprises a decoy assembly comprising a plurality of L-shaped legs, in which a two or three dimensional decoy is attached to each vertical member of the L-shaped legs, the horizontal member of each of L-shaped leg being pivotably affixed to a pivot point.

### BACKGROUND OF THE INVENTION

The present invention relates to animal decoys and particularly to a fowl (duck, geese, etc.) decoy assembly in which a plurality of decoy members are mounted on a support member, which has two or more legs, each supporting one decoy. The support member is movable from a closed, collapsed storage or carrying position to an open use position. Decoy assemblies which expand from a collapsed storage position to an expanded use position are generally well known and include those in which the several decoys, are outlined in profile. Generally the profile type decoys permit assembly collapse, that is, both the decoy members and their support fold or otherwise collapse as a unit for ease in storage or carrying from place to place.

Two dimensional photographic or colored cut-outs of fowl are used as decoys. These are for use on hard surfaces such as fields, ice, etc., as opposed to placement on the water. These photographic or colored images are quite realistic and effective and are mounted on a stake and pushed into the ground. Often however, fowl hunting is done in the winter when the ground is frozen solid and pushing a stake into the ground is impossible. Also, these decoys are mounted one on a stake.

A hunter will normally use anywhere from one dozen to ten dozen of these decoys, deployed in a field.

### SUMMARY OF THE INVENTION

The present invention comprises a novel profile type decoy assembly. A plurality of decoys are mounted on a single assembly which sits on the ground in a stable manner and does not have to be driven into the ground. The assembly folds into a simple, easy to carry unit. This is important as many of the units may need to be carried from a vehicle to the hunting site, and this would be very inconvenient unless many units could be carried in one trip.

This is accomplished by having an assembly unit which has a plurality of L-shaped legs which are connected to one or more pivot points, so that the legs can be folded into a flat profile for movement and storage. Each leg may have a slightly different length, so that all the legs fold without obstruction.

### OBJECTS OF THE INVENTION

Accordingly, it is an object of the present invention to provide a decoy assembly which can be used on a hard surface hunting site, where insertion of stakes in the ground, into ice, or any hard surface, is difficult or impossible.

It is a further object of the invention to provide a decoy assembly which holds multiple two-dimensional or three dimensional decoys and folds into a simple form for storage and transportation.

It is yet a further object of the invention to provide a decoy assemble which allows the hunter to carry and deploy a large number of decoys at a hunting site, with a minimum of time necessary to set up an array of decoys.

Yet a further object of the invention is to provide a decoy assembly in which the decoys are easily changeable, and thus usable for a variety of game species or for positioning.

These and other objects of the invention are accomplished by a decoy assembly in which a two-dimensional or three-dimensional decoy is removably affixed to the vertical member of an L-shaped leg, where a plurality of L-shaped legs are each pivotably affixed to a pivot point. As each of the legs is spread from the pivot point, the decoys are deployed in a random manner at a hunting site and the decoy assembly has a firm and stable base, quite capable of standing, even in the face of a substantial wind. In addition, the horizontal base members can easily be hidden in the low grass or brush of a field, so as not to be visible to the game.

Other objects, features and advantages of the invention shall become apparent as the description thereof proceeds when considered in connection with the accompanying drawings.

### BRIEF DESCRIPTION OF THE DRAWINGS

FIG. 1 is a perspective view of the decoy assembly of the present invention;

FIG. 2 is a side view with the legs all folded together;

FIG. 3 is a top view thereof;

FIG. 4 is a perspective view of an alternate embodiment;

FIG. 5 is a perspective view of another embodiment;

FIG. 6 is a perspective view of another embodiment; and

FIG. 7 is a perspective view of another embodiment.

### DETAILED DESCRIPTION OF THE INVENTION

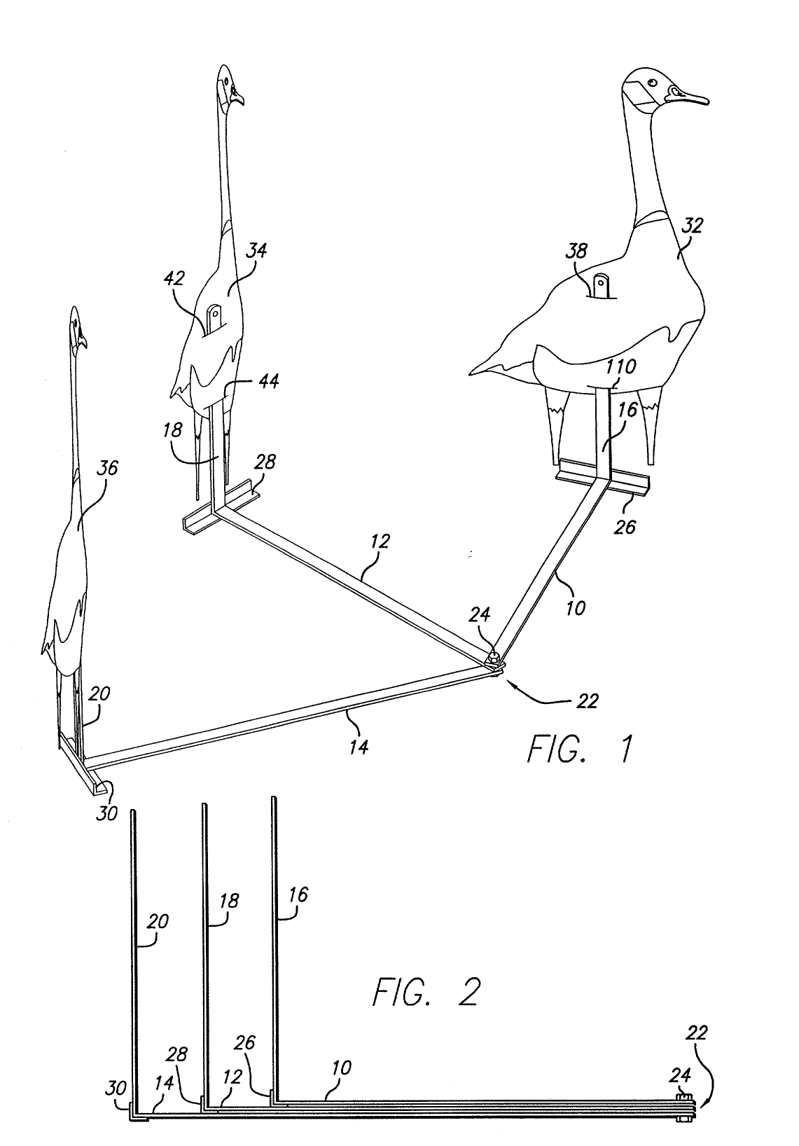

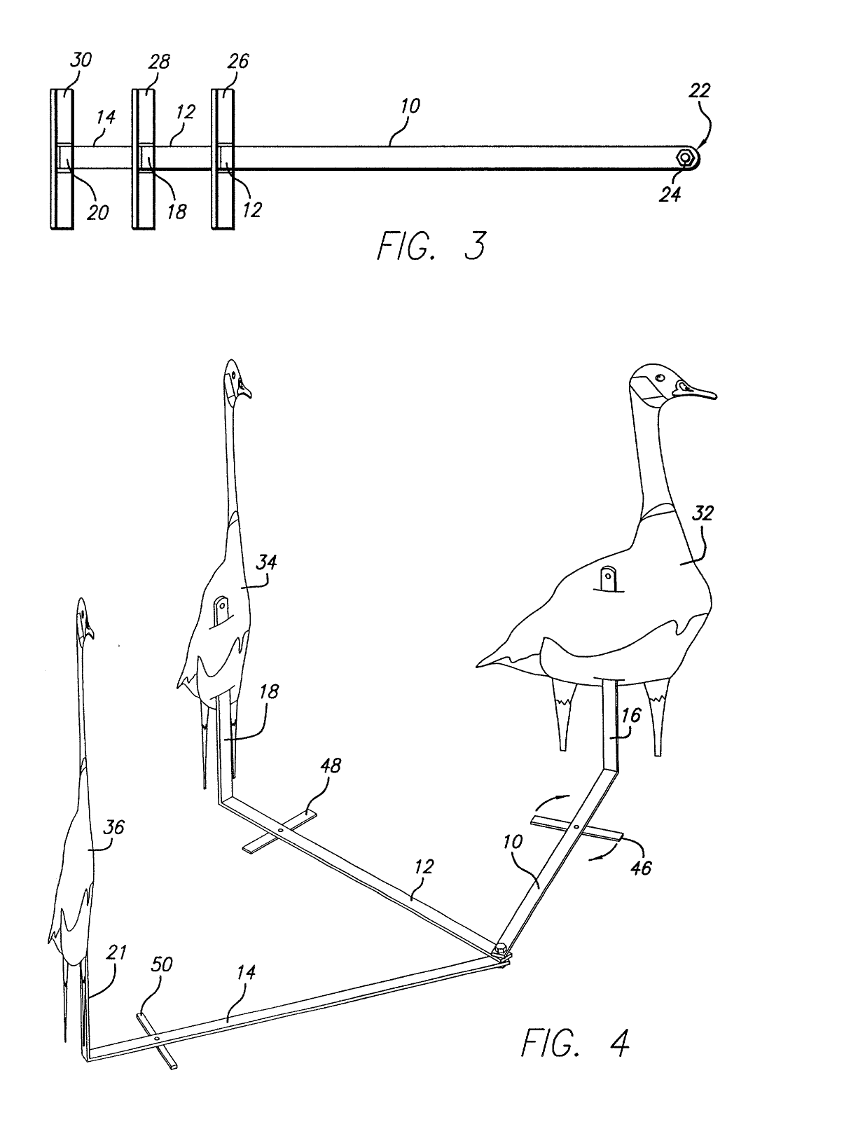

Referring now to FIGS. 1-3, there are shown, three L-shaped legs, having horizontal members or legs 10, 12 and 14 and vertical members or legs 16, 18 and 20. One end of each of the three horizontal legs 10, 12 and 14 is pivotably connected at a common pivot point 22 and held together by a fastener, such as bolt 24.

At the end opposite to pivot point 22 of each horizontal leg 10, 12 and 14 are optional cross-members 26, 28 and 30. Cross-members 26, 28 and 30 help to provide balance to the assembly, helping to maintain stability of the assembly when deployed in a field, on ice or other surface. The assembly will operate without cross-members 26, 28 and 30, however they do provide more stability if needed.

Decoys 32, 34, and 36 (shown in FIG. 1 only) are removeably affixed to each of the three vertical legs 16, 18 and 20. Decoys 32, 34 and 36 each have two slits therein, 38, 40, 42 and 44. The decoys are affixed by passing vertical legs 16, 18 and 20 through the lower slit and then through the upper slit. While the decoys shown are attached using a pair of slits, other methods of holding the decoys on the vertical members may be used, such as clips, snaps or fittings. If three dimensional decoys are used, they may be attached by other fittings such as a male-female connector.

Horizontal legs 10, 12 and 14 are of consecutively slightly different lengths. This provides the ability to pivot all three legs 10, 12 and 14 into a straight line, for ease of storage and transportation. Even with the decoys attached, the horizontal legs can be pivoted to a straight line. The apparatus will operate even if the horizontal legs are all the same length, however the apparatus will not then fold up into a straight line.

Fastener 24 holds the three legs frictionally sufficiently tightly together, so that it takes some effort to pivot legs 10, 12 and 14. This is so that the assembly can be picked up at the pivot point while legs 10, 12 and 14 are deployed radially and the legs will not pivot to the closed, straight line position, where fingers could be caught between adjacent legs. The apparatus will operate even if the legs are not held tightly, however there is the danger of fingers being caught if the legs swing together.

While three legs are shown, the assembly could have from two to any convenient numbers of legs, such as ten, each being optionally a slightly different length, in order that they can be folded together into a straight line.

FIG. 4 shows an alternate embodiment having horizontal legs 10, 12 and 14 and vertical legs 16, 18 and 20. Decoys 32, 34 and 36 are affixed as set forth above. The difference in this embodiment is that cross-members 46, 48 and 50 are pivotably attached to horizontal members 10, 12 and 14 at a point between the ends of legs 10, 12 and 14, enabling cross-members 46, 48 and 50 to pivot to a straight line, providing an even more convenient profile for storage and transportation.

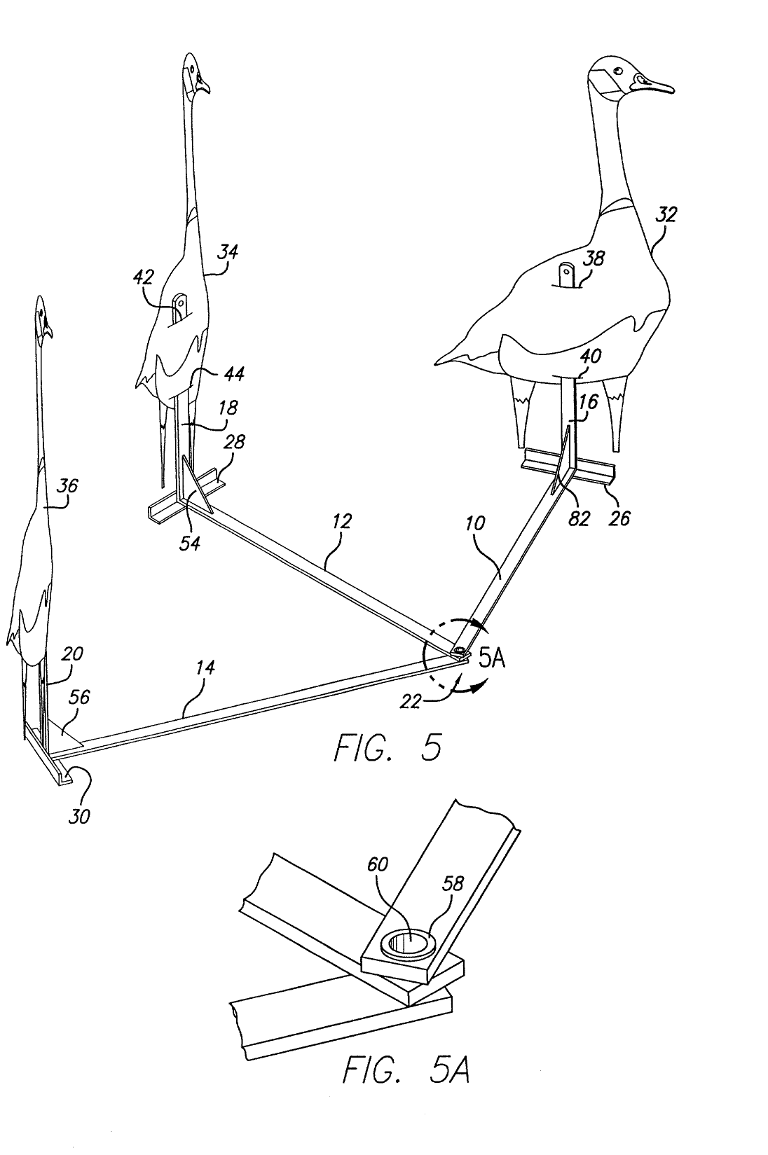

FIG. 5 shows another embodiment, particularly useful if the assembly is made from a less sturdy material such as plastic, however the design is applicable too all materials. The assembly, horizontal and vertical legs and cross-members, can be made of any convenient material, such as wood, iron, steel or aluminum, or they can be made from a plastic, or any other convenient material. In this case horizontal legs 10, 12 and 14, vertical legs 16, 18 and 20 and cross-members 26, 28 and 30 are made of a less sturdy material such as plastic or wood. Because plastic or wood is not as sturdy as metal, support members 52, 54 and 56 are provided at the intersection of the horizontal and vertical legs, for extra support and strength.

FIG. 5A shows pivot point 22 in which a rivet 58 holds the three horizontal legs together. Rivet 58 has a hole 60 through its center. Hole 60 allows either a small diameter rod or stake to be passed through, which could be fastened in the ground, if desired. Also, hole 60 allows a rod to be passed through a number of assemblies, which can then be carried together, hanging on the rod.

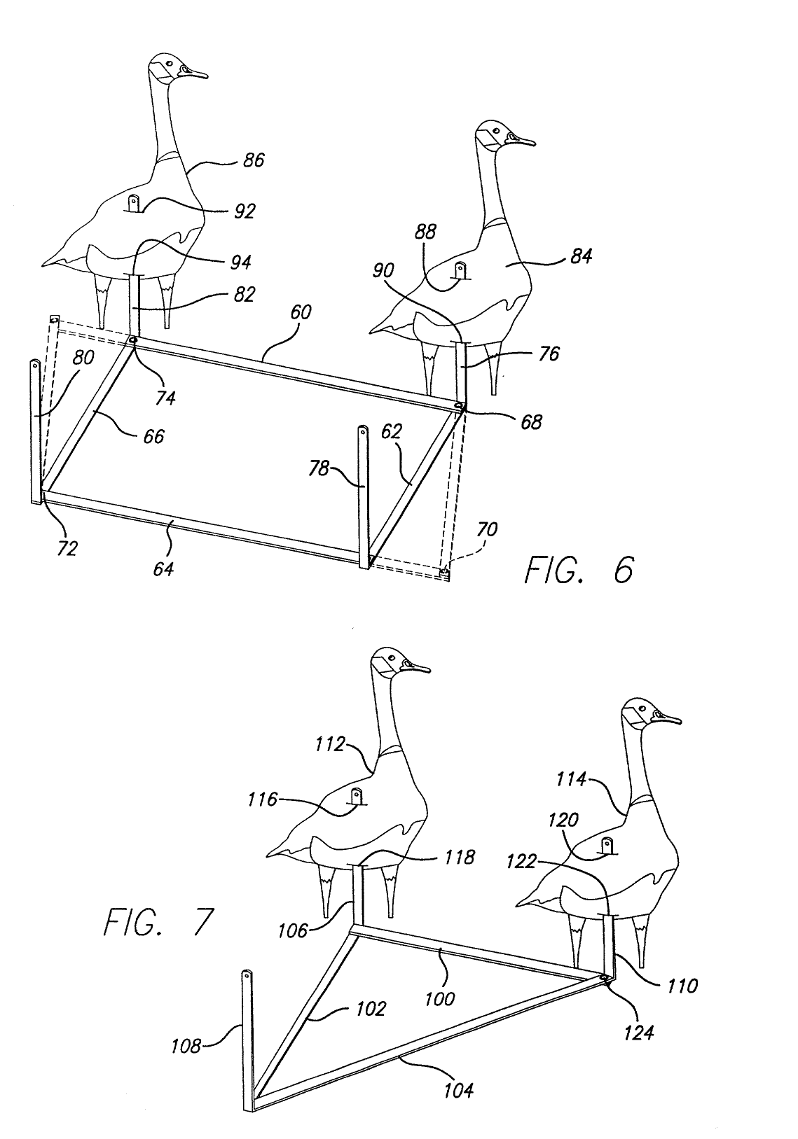

FIG. 6 shows another arrangement in which the assembly comprises four horizontal legs 60, 62, 64, and 66 which are attached together at pivot points 68, 70, 72 and 74. Vertical members 76, 78, 80, and 82 hold decoys 84 and 86 by use of slots 88, 90, 92 and 94, similar to FIG. 1. Only two decoys are shown for convenience, however two more decoys will be mounted on vertical members 78 and 80.

When not in use the assembly collapses or folds down at pivot points 68, 70, 72 and 74, to a narrow or straight profile for ease in transportation and storage.

FIG. 7 shows another embodiment having three horizontal members 100, 102 and 104 and three vertical members 106, 108 and 110. Decoys 112 and 114 are attached by slits 116, 118, 120 and 122, to vertical members 106 and 110. There can also be a decoy on vertical member 108 but it is left off here to allow better viewing of the assembly. This assembly also folds up in that horizontal members 100 and 104 are pivotably attached at rivet 124. Horizontal members 102 and 104 are pivotably attached by a rivet (not seen) where they meet. However, horizontal members 100 and 102 are not attached at all, allowing both members 100 and 102 to pivot down to member 104, again providing a narrow profile for storage and handling.

The vertical legs of each assembly are usually fixed at 90 degrees to the horizontal but they may be fixed at anywhere from 45 degrees to 90 degrees as desired. The horizontal and vertical members may be made from flat bars, round bars or any other shaped bars.

The assemblies may be utilized in a field, on ice, on sandbars, shorelines or meadows. The pivot points may be made by the use of any pivotable fastener such as a bolt, rivet or other fastener.

In use, a hunter will normally deploy from one dozen to ten dozen decoys at a hunting site to lure game, such as ducks or geese, to the site. Two dimensional decoys are quite effective. Two dimensional decoys made today are of two type, one is painted to look like the fowl, the other is made photographically. Any decoy, both two and three dimensional, may be used with the assembly of this invention. While the attachment is shown using slits in the decoys, the decoys may be attached in any convenient manner, such as using attachment clips or pins. They could also be permanently affixed, however being removeably affixed allows the hunter to change positioning or change the decoys to other species.

If the hunter cannot drive all the way to the hunting site to drop off the decoy assemblies, the hunter will carry as many assemblies as he can from his vehicle to the site and disperse the assemblies throughout the site, field, iced lake, etc. He may then have to go back to his vehicle and get more assemblies. The horizontal legs are pivoted out at any angle that the hunter desires to create a dispersal of the decoys. The horizontal legs can be hidden in the grass or brush so as not to be visible to the game. The horizontal and vertical legs, or the whole assembly, can be painted in camoflauge paint. Some game are quite careful and normally alight in the middle of a field, not near the edges. They watch closely for predators. Thus, a well placed and hidden decoy assembly is critical to success.

Although the assemblies would operate without cross-members, they provide more stability when stored and when deployed. The assembly of this invention is self-standing and self-supporting. No stakes or other outside components are needed. They can be closed or folded up easily for transport or storage.

The decoys can be faced or reversed in either direction allowing versatility in positioning. They can be made of any material such as steel, iron, aluminum, wood or plastic. They can be used with any type of animal decoy species. The vertical and cross-members are attached to the horizontal members by welding, rivets, pins, snaps or other means.

The legs can be made of any length and height, they can be of any color or finish, although a camouflage print is the most effective.

As an addition, the vertical legs could be mounted on springs or swivels to simulate movement of the decoys.

Having thus described the invention,

We claim:

1. A decoy assembly for game decoys comprising a plurality of L-shaped legs, each leg having a horizontal member and a vertical member, the horizontal members of each leg being pivotably affixed to a pivot point, means to affix a game decoy to each vertical member.

2. The decoy assembly of claim 1 in which the decoys are removeably affixed.

3. The decoy assembly of claim 1 in which horizontal cross-members are affixed at the intersection of each horizontal member and vertical member.

4. The decoy assembly of claim 1 in which the vertical members are set at an angle of 45 degrees to 90 degrees to the horizontal members.

5. The decoy assembly of claim 1 in which a plurality of legs are all rotatably attached to one pivot point.

6. The decoy assembly of claim 5 in which the legs are frictionally, rotatably attached, so that the legs will not swing together without pressure.

7. The decoy assembly of claim 1 in which the entire assembly is covered in a camouflage print.

8. The decoy assembly of claim 1 in which the assembly is made of wood, plastic, iron, steel or aluminum.

9. The decoy assembly of claim 1 in which the pivot points comprise rivets or bolts.

10. The decoy assembly of claim 1 in which the decoys have two slits therein, for attachment to the vertical members.

11. The decoy assembly of claim 5 in which each horizontal leg is a different length.

12. The decoy assembly of claim 9 in which the pivot points comprise rivets, each rivet having a hole passing through it.

13. The decoy assembly of claim 1 in which the decoys comprise two dimensional or three dimensional decoys.

14. The decoy assembly of claim 1 in which support members are affixed at the intersection of each horizontal member and vertical member.

15. The decoy assembly of claim 13 in which the decoys are attached to the vertical members by slits, clips, pins or male-female connectors.

16. A decoy assembly for game decoys comprising a plurality of L-shaped legs, each leg having a horizontal member and a vertical member, the horizontal members of each leg being frictionally, pivotably affixed to a common pivot point, means to affix a game decoy to each vertical member.

17. The decoy assembly of claim 16 in which the decoys are removeably affixed.

18. The decoy assembly of claim 16 in which horizontal cross-members are affixed at the intersection of each horizontal member and vertical member.

19. The decoy assembly of claim 16 in which the vertical members are set at an angle of 45 degrees to 90 degrees to the horizontal members.

20. The decoy assembly of claim 16 in which the entire assembly is covered in a camouflage print.

21. The decoy assembly of claim 16 in which the assembly is made of wood, plastic, iron, steel or aluminum.

22. The decoy assembly of claim 16 in which the pivot points comprise rivets or bolts.

23. The decoy assembly of claim 16 in which the decoys have two slits therein, for attachment to the vertical members.

24. The decoy assembly of claim 16 in which each horizontal leg is a different length.

25. The decoy assembly of claim 16 in which the pivot points comprise rivets, each rivet having a hole passing through it.

26. The decoy assembly of claim 16 in which the decoys comprise two dimensional or three dimensional decoys.

27. The decoy assembly of claim 16 in which support members are affixed at the intersection of each horizontal member and vertical member.

28. The decoy assembly of claim 16 in which the decoys are attached to the vertical members by slits, clips, pins or male-female connectors.
